(19) United States
(12) Patent Application Publication
(10) Pub. No.: US 2006/0212311 A1
(43) Pub. Date: Sep. 21, 2006

(54) Class of medications is proposed, named RPhX®

(76) Inventor: Nazeeh Bestourous, Kew Gardens, NY (US)

Correspondence Address: Nazeeh Bestourous, 118-11 84th Ave. # 609, Kew Gardens, NY, 11415, US

(21) Appl. No.: 11/081,991

(22) Filed: Mar. 16, 2005

(51) Int. Cl. G06Q 10/00

(52) U.S. Cl. 705/2

(57) ABSTRACT

The invention is based on creating a new Class of medication to be a transitional class between Rx Medication and OTC Medication. The new Class is to be named RPhX, and is primarily authorized and dispensed by a pharmacist. As the patient requests an item in the RPhX class, a licensed pharmacist must perform drug review of the patient's medication to avoid drug allergy, Interaction etc. A pharmacist can write a prescription for this RPhX class. Certain information is needed including the Facility of Practice, Address, Telephone Number, Pharmacist name, License number, Signature, Medication name, Strength, and Amount, to be documented on the prescription. The new Class of Medication present an economical benefits by reducing the overall healthcare spending.

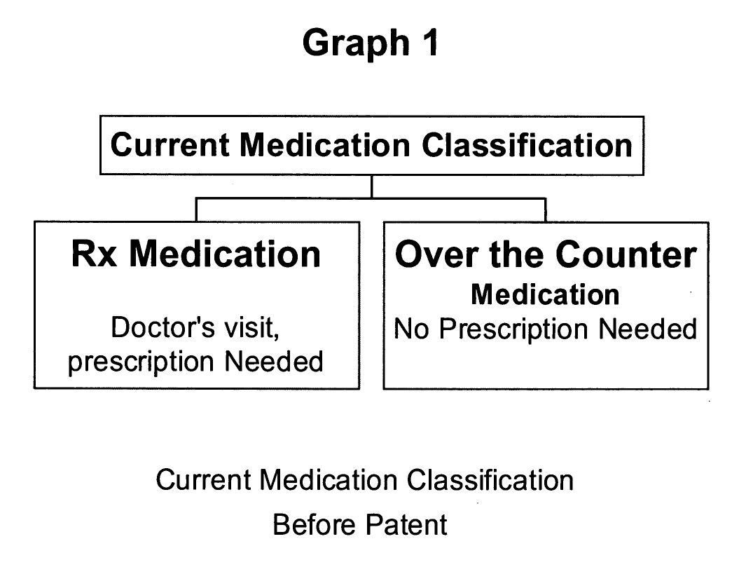

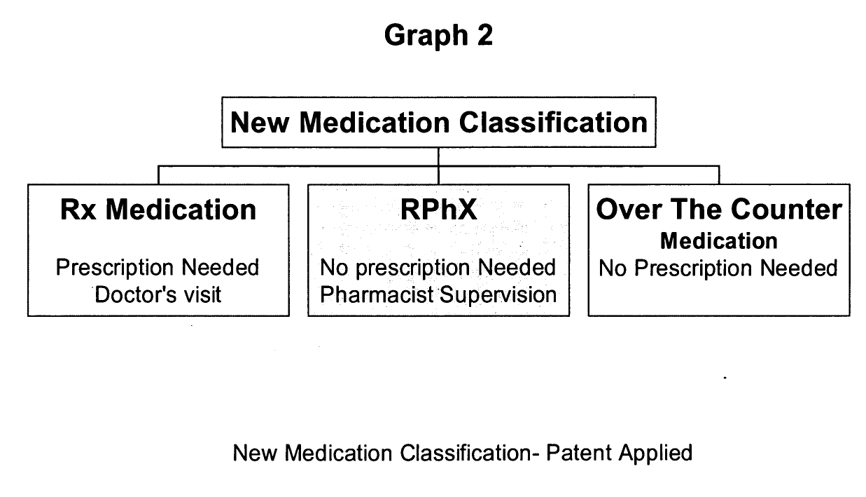

### CROSS REFERENCES TO RELATED APPLICATION

A search of the database related to this issue found no similar inventions. The basis of current classification is based on the Durham-Humphrey Amendment (1951) which defines the kinds of drugs that cannot be safely used without medical supervision and restricts their sale to prescription by a licensed practitioner.

### STATEMENT REGARDING FEDERALLY SPONSERED RESEARCH OR DEVELOPMENT

Not Applicable

### BACKGROUND OF THE INVENTION

The current classification of medication is composed of OTC and Rx medication.

Over-the-Counter Medication (OTC): Medication items are widely available in a Pharmacy or Drugstore. Patients pick the items off the shelves, treating simple health problems. Patients are medicating themselyes. Compatibilities with other medication may be an issue, drug-drug interaction, drug food interaction, medication duplication therapy, and or therapeutic duplication can be a problem for certain demographics. The OTC items are limited in numbers due to its wide availability however they are properly priced. The low cost of OTC medication is due to many factors, but mainly due to absence of Insurances involvement and doctors visit to obtain such medication. The Food and Drug administration approves the items to be placed in the Over the Counter Medication when it is relatively safe to be used without medical supervision.

Medication. OTC helps reduce the overall healthcare cost by estimated $25 Billions annually in time spent, doctors visits, Insurances involvement, etc.

Rx Medication, are items dispensed only by prescription from authorized practitioners based on the Durham-Humphrey Amendment which defines the kinds of drugs that cannot be safely used without medical supervision, usually obtained through a clinic, hospital, and or MD offices etc. Insurance and co-payment play a big part in this class.

The Rx section includes Brand name medication and Generic Medication. Due to the prescription restriction on these items, the cost of 10 tablets of any Rx medication results in a cost of doctor's visit, insurances processes, pharmacist dispensing the medication, Insurance, co-pay, etc. A total cost varies greatly, ranges from hundreds to thousands of dollars. Putting the same restrictions on buying cars for example will drive the cost 20 folds.

Brand name medication have an army of salesmen/women of their respective companies, proactively promoting its use by all means possible, television advertisements, frequent visits to MDs offices, Hospitals, Clinics, distribution of Samples, Gifts, Note Pads with Logos, Lunches, Dinners, Mail prints, Seminars, Lectures, and by all means available. Estimated Promotional and advertisement reach almost $16 Billion per year. These promotional tactics pushes the items to the front line for doctors and patients alike.

Some of these new medication or its uses, proved to be unsafe for the health of the patients in the short and/or the long term. As a result, some have been limited in its use or withdrawn completely from the market.

Generic Medications have been in the market after the patent for brand name items expired. The generic medications are studied (as Brand and later as Generic) for as long as 10 years, 20 years, or 30 or more years. Since Generic medications cost 1-3% of the respective Brand name medications, accordingly no money to promote Generic items. Generics take a back seat to the new, hot, heavily promoted Brand name items. Physicians, Clinics, Hospitals, and Patients' attention is directed away from the simple, cheap, safe, well studied generic medications to the new expensive hot item.

A review of the prices alone of medication on a prescription with cost $100 for a month supply may cost $15 when the item is over the counter. Because the Rx medication are tied to a physician visit, Rx prescriptions are mainly written for the full course of treatment or a standard one-month supply. In addition Rx medications may not be used in full, due to its side effects, intolerance, or not needed anymore and as a result are considered a waste of resources.

The Joint Commission of Accreditation of Healthcare Organization (JCAHO) is a non-profit organization that accredits Hospitals, Nursing homes, and similar healthcare organizations to stay in business. Healthcare Organization must pass the JCAHO inspection in order to stay in business and to serve the Medicare, and Medicaid patients. The JCAHO requires pharmacists' close monitoring of patients treatment, medication administration, physician orders of medication. It also requires a pharmacist to review Physician orders of medication for dose, allergy, duplication, therapeutic levels, etc., before the medication is dispensed and administered to the patient. These requirements among others can't be ignored for the organizations to stay in business.

The Economics of the healthcare system and the spending pattern brings great concern to Small and Large Businesses, Insured and Uninsured Individuals, and to the Country in general, due to the direction the healthcare system cost is hiding. Annual increases in spending of the healthcare resources increases greatly, much more than twice the annual percentage inflation, more over, the number of insured decreases greatly on an annual basis. The insurance coverage decreases, while limitation on coverage and co pay increases. Thus the increase in healthcare cost and spending may have reach an annual of 20% considering the uninsured, under insured, undocumented, out of pocket expenses required, etc. An accurate estimate of the increase in the cost of healthcare services is unknown.

With many complaints regarding loss of manufacturing jobs, and currently computer related services out sourced to other countries, it is imperative to act now before healthcare services become more convenient if performed outside of United States of America and more affordable to the common patients.

There are conflicts of interests and ethics between approval and disapproval of medication reimportation between different parties of authorities. While the law doesn't allow importation or reimportation of medication based on the safety issues, patients particularly senior citizens, and low-income individual can't pay for the full quantities of medication, thus creating a dilemma. High cost of medication in USA, or half price in other countries. Enforce the law and have patients without medication or assist the patients and change the law, etc.

The communication and through the Internet is changing the world today to a different understanding to many issues. Healthcare is one, among other issues. The question is why would we pay so much for so little while similar countries pay much less for the same?

Many articles in several pharmaceutical magazines reported several counterfeit of popular and high cost items in the US Market.

Voluntary recalls of medication is an ongoing process that happens all the time. This occurs through a system of communication with wholesaler, Hospitals, Drug store, and many are posted on various websites. “Voluntary” does not negate the fact that it is a serious matter, where legal action can be followed if the company didn't pull the particular lot numbers off the market.

Enforcing the law against importation or reimportation of medication by individual who needs the medication but can't afford it, opens the door widely to the pharmaceutical companies to maintain higher prices of medication in the United States, and make it look as if the Government working against the patients and for the Pharmaceutical companies.

Importation of medication to the US markets happens all the time. The pharmaceutical companies manufacture or contract manufacturers to produce items where quality and economics are available, and then ship it to the US market and other markets around the world.

Where goods and services in an open market inches up in prices very slowly and sometimes bounce back, inflation and deflation occurs as expected in an open market. The healthcare Industry leaps only one way in prices and cost that can't be sustained. It does not follow the open market style because it is controlled by rules and regulation that needs to be updated. The system is structured as such.

### BRIEF SUMMARY OF THE INVENTION

Create a new Class of medication to be a transitional class between the Rx Medication, dispensed by prescription, and Over The Counter Medication where patients need no prescription to buy medication to help cure, alleviate, a problem.

The new Class is to be named RPhX®, (Registered Pharmacist Prescription) authorized to be dispensed and dispensed by a licensed pharmacist without a need for a physician visit or prescription. However authorized prescriptions are honored.

This New Class is to be formed of RX, OTC, Dietary Supplement, Herbal Medicine and items with Medicinal Claim (s), currently available and or to come to the market in the future.

As the patient or a representative presents a need for an item of the RPhX class, a pharmacist is required to review the medication taken by the patient and identify duplication, drug interaction, etc., before dispensing the medication.

A Licensed pharmacist may write a prescription for this RPhX class to be dispensed by a licensed pharmacist. Certain information is needed including the Pharmacist name, License number, Signature, Facility name, address, telephone number, medication name, strength, and the quantity, to be documented on the prescription.

The new Class of Medication RPhX presents a great economical benefits to Pharmaceutical companies, healthcare organizations, providers, various Insurance companies, millions of uninsured, under insured, undocumented individuals, and a relief to the overall healthcare spending.

RPhX class presents Simplification of the process, Availability of the items, Time Utilization Improvement, and creates new Dynamics, and Synergy in the processes.

### BRIEF DESCRIPTION OF THE GRAPHS

Graph 1 represents a simple current classification of the medication available. This is mainly (Rx) Medication dispensed based on an authorized prescription and Over the Counter Medication (OTC) where no need for a prescription or MD visit.

Graph 2 represents a simple classification with the invention implemented. It shows three sections, which are Rx, RPhX, and OTC

1. (Rx) Medication dispensed based on authorized prescription,

2. (RPhX) no prescription is needed but honored. The items are supervised by a pharmacist

3. Over the Counter Medication, no prescription needed

Two Graphs are located at the end of the folder.

### DETAILED DESCRIPTION OF THE INVENTION

Create a new Class of medications; this class would be a transitional state between (Rx) Prescription Medications where authorized prescriptions are needed for dispensing the items and (OTC) Over the Counter Medication where no prescription is needed to obtain the medications.

The new Class claimed in #1 would be identified as:

RPhX® (RPhX and similar letters, different arrangement with different Fonts, Type size, Display, Character, color) short for Registered Pharmacist Prescription.

A new Class of Medication per claim #1 is to be authorized and dispensed primarily by a licensed pharmacist, without a need for a prescription, Insurance or an MD visit. Authorized prescriptions are also honored.

Upon a request of an item in the class RPhX, a licensed pharmacist performs drug review of patient's overall medication use, in order to identify duplication, drug-drug interaction, improper use, dose adjustment, and other adverse reaction. This will help reduce unnecessary cost, misuse, hospitalization due to adverse reaction, and or sub-therapeutic treatment, in addition to assure optimum therapeutic outcome. A pharmacist has the option to dispense the medication or refer the patient to a clinic, doctor etc.

A new Class of medication per claim #1 promotes an economical aspect to the total medication annual spending which reached recently to $162 Billion. This economical incentive will reduce the overall cost of medication particularly those in this RPhX class, and in-turn the total healthcare spending.

A new Class of medications according to claim #1 to be formed of items or medication mainly approved by the Food and Drug Administration, Dietary Supplements, Herbal Medicine, and items with Medicinal claim (s), currently available in the market, being developed, and to come to the market in the future.

A new Class of medications according to claim # 1 allows Pharmaceutical Companies, Food and Drug Administration, and Various Organizations, to request that certain Rx medications to be switched to the new class (RPhX) based on its safety, Risk/benefit balance, and economical value.

A new Class of medications according to claim # 1 allows Pharmaceutical companies Food and Drug Administration, and various organizations to request to place certain OTC items, Dietary Supplement, Herbal Medicine, New medications coming to the market, and items with Medicinal claim(s), into this class. This will help reduce improper utilization, abuse, or misuse of these items without denying its availability.

A new Class according to claim # 1 is based on the fact that many medications would be safely used if placed in the new class RPhX under a pharmacist's supervision. This will help maintain a low cost of medication with professional assistance in addition to the low cost of Over the Counter medication prices.

A new Class of medications according to claim #1 has Pharmacist's knowledge, experience, professional help and support behind the items in proper utilization.

Based on Claim in #3 per patient request, a pharmacist who is a member of a hospital, a clinic, an outpatient service, may dispense the proper RPhX medication or write a prescription for the items on RPhX to be dispensed by a licensed Pharmacist in a drug store, or a pharmacy, etc. Information must be complete as to the Medication Name, Strength, Amount, the Pharmacist name, License number, Signature, Facility or service name and Telephone number.

Based on Claim in #3, a pharmacist, upon receiving an RPhX prescription, or a patient request of an item in this class, would review the patient information and medication uses. Enter the information into the computer system and review proper usage, absent of drug-drug interaction, duplication, usage etc., before dispensing the medication. Based on the situation, a pharmacist may dispense the medication or refer the patient to a physician, Clinic, Hospital, etc.

Based on the claim # 5 and in the interest of simplification, the relation between

A—Cost of Brand Medication VS its Generic is 100 to 1-3 in Dollar amount.

B—Cost of Rx Medication vs. OTC Medication is estimated as 100 to 10 in dollar.

C—Cost of Healthcare spending to Medication spending is 100 to 10.

D—Over the Counter Medication reduce overall healthcare cost by more than $20 Billion per year in time spent, doctors utilization etc. The new class of medication will have new dynamics and synergism that will reduce the cost of medication greatly and impact other classes as well.

The class claimed in # 1 generates savings that ranges from 50% to 95% in some cases depending on these relationships mentioned and implementation of the invention in full or part.

The new Class, of medications “RPhX” in claim #1& 2 will be formed mainly of RX Brand and Generic medications, OTC, Herbal Medicine, Dietary Supplements, and items with Medicinal claims, currently available in the market or to be introduced in the future. Patient can stop by a Pharmacy, visit a Hospital, Clinic, or similar services, see a pharmacist and be evaluated and medication prescribed, and dispensed, to help the patient over come simple problems. Also Patient can have Medication Management evaluation, early screening and referrals through the same. Certain restrictions can be implemented on this category such as dispensed by a Licensed Pharmacist, duration of use, and documentation, etc.

This invention provides time utilization improvement by reducing the process and cost of obtaining these items when properly needed, from days to less than an hour, as long as there is a need for the item and an operating pharmacy.

### Advantage of this Invention

Encourages the Pharmaceutical companies, The Food and Drug Administration, and Insurance companies to have many of these well studied Generic medication in this category without concern of having the medication widely available Over the Counter.

Helps promote the generic medication that is safe, and effective. These medications costs 1% of the price of its comparable brand name.

Help increase the utilization of current registered Pharmacist, 350,000 Pharmacists, in Hospitals, Clinics, and Retail, to participate as provider of service, and early screeners for healthcare problems.

Improves MD's time utilization.

Better Public safety and medication utilization for OTC, RPhX, and Rx medication, Dietary items, Herbal Medicine, and items with Medicinal claim (s).

Reduce cost to the insurance companies, including Medicare, and Medicaid.

Prevent unnecessary use of Brand Name Medication when Generic is available for nominal prices.

Help solve the problem of reimportation of medication from Canada and others as the prices level off, and prevent future outsourcing of health services from happening by maintaining cost containing measures.

Companies will be encouraged to place more of their medication in this class, closer to OTC but with better management and RPh control, thus treating OTC with the same safety as Rx medication.

Helps 45 millions uninsured, Millions of underinsured, and undocumented patients to have access to healthcare services, medication management and early screening.

Patients, as well as Healthcare providers, benefit from pharmacists' knowledge and service in drug utilization and medication use review. Reduce drugs misuse and unnecessary hospitalization of thousands of patient per year which is estimated of Billions of dollars annually

Pharmacy schools will respond in adjusting their current programs to accommodate the new category, thus improving the overall education

This Patent will help reduce healthcare spending by $ 100 Billions annually, estimated, as more items are placed in the new class.

This class RPhX provides time savings in obtaining these items, as long as a pharmacy is in operation.

Create a stronger connection between Pharmacists and patients and more frequent patients' medication review by a pharmacist.

Great Economical incentives by reducing the general healthcare medication cost and overall Healthcare spending.

This Invention will create new Dynamics and synergism in lowering the cost of medication and the overall savings in the Healthcare spending. Time savings, promote Generic items (safe, and nominal cost), Medication utilization Management, absent of Insurance Involvement, small quantities of medication dispensed, more pharmacists involvement, early screening, etc

What I claim is:

1. Create a new Class of medications; this class would be a transitional state between (Rx) Prescription Medications where authorized prescriptions are needed for dispensing the items, and (OTC) Over the Counter Medication where no prescription is needed for dispensing the medications.

2. The new Class claimed in #1 would be identified as:
RPhX® (and the like RPhX RPhX RPhX RPhX RPhX) regardless of the Fonts, Type size, Display, letters arranged, Character, and Color, short for Registered Pharmacist Prescription.

3. A new Class of Medication per claim #1 is to be authorized and dispensed primarily by registered pharmacists without a need for a prescription, however authorized prescriptions are honored.

4. The new class per claim #3, upon a request of an item or more of this class of medication by a patient or representative, a Licensed pharmacist perform drug review of patient's overall medication utilization, update patient profile of medication, identify Allergy, duplication, drug-drug interaction, drug-food interaction, improper use, abuse, dose adjustment, other adverse reaction. Data may be entered into a computer system. This will help reduce unnecessary cost, misuse, hospitalization due to adverse reaction, and or sub-therapeutic treatment. A pharmacist has the option to dispense the medication or refer the patient to a hospital, clinic, etc.

5. A new Class of medication per claim #1 promotes new dynamics and synergism in lowering the prices of medication in this class and in the Rx class. The new dynamics is created due to, time utilization improvement of healthcare providers, availability of medication as needed, focus on Generic items which is safer and with nominal cost, availability and utilization of 350,000 Pharmacists, Amount dispensed, Waste, Insurance factor, Early screening, productivity of patients and their time savings etc. The economical incentive will reduce the soaring cost of medications on an annual basis and in turn the overall healthcare spending. The total medication annual spending reached $162 Billion recently.

6. A new Class of medications per claim #1 to be composed of items or medication mainly approved by the Food and Drug Administration, available in the market, in the process of being developed or coming to the market in the future. Those include, Generic medication, Over The Counter Medication (OTC), and items available as Herbal Medicine, Dietary Supplements, and items with Medicinal claim (s). Brand name medication can also be added.

7. A new Class of medications per claim # 1 allows Pharmaceutical Companies, Food and Drug Administration, and Various Organizations, to request that certain Rx medications, in the market or coming to the market in the future, be switched to the new class (RPhX) based on its Safety, Risk/benefit balance, and Economical value.

8. A new Class of medications according to claim # 1 allows Pharmaceutical companies, Food and Drug Administration, and Various Organizations, to request to place certain OTC items, Dietary Supplement, Herbal Medicine, items with Medicinal claims, currently in the market or coming to the market in the future, etc. into this new class (RPhX). This will help reduce improper utilization, abuse, or misuse of these items without denying its availability.

9. A new Class according to claim # 1 is based on the fact that many medications would be safely used if placed in the new class, under a pharmacist's knowledge, experience, and professional support in monitoring proper utilization.

10. Based on claim in #1, per patient request, or a representative, a pharmacist who is a member of a hospital, a clinic, a pharmacy, a drugstore, or an outpatient service, may dispense the proper RPhX medication. A licensed pharmacist may write a prescription for the items to be dispensed by a Licensed Pharmacist in a drug store, or a pharmacy. Information on the prescription must be complete as to the Medication name, Strength, Amount, the Pharmacist name, License number, Signature and Facility Name, Address and Telephone number. The prescription must be identified as specifically for this RPhX class by color, print or prints of RPhX, or both, etc.

11. Based on the claim # 5 and in the interest of simplification, the relation between Brand Name Medication, Generic Medication, Prescription Medication, Non Prescription Medication, Medication spending, Total Healthcare Spending, Inflation, and Rate of Annual increase of the cost and spending, can be simplified on the following
A—Cost of Brand Medication VS its Generic Medication is $100 to $1-3.
B—Cost of Rx Medication VS. OTC Medication is estimated as $100 to $10.
C—Cost of Healthcare spending to Medication spending is 100 to 10.
D—Increase in Healthcare Spending exceeds 12% annually.
E—The number of uninsured, under insured, undocumented is increasing annually.

12. The class claimed in # 1 generates savings that ranges from 50% to 95% in some cases depending on these relationships mentioned above and the implementation of the RPhX patent in full or in part.

13. The class claimed in #1 presents time utilization improvement as availability of RPhX items improves from days to less than an hour as long as a pharmacy is operating. This accommodation will help reduce the overall cost associated with obtaining these items and overall spending.

14. The new class in claim #1 would have certain restrictions be implemented on this category such as limited time usage, a registered Pharmacist Supervision, a Pharmacist review of medication utilization by the patient, and Documentation, etc.
